(19) United States
(12) Patent Application Publication
(10) Pub. No.: US 2026/0184607 A1
(43) Pub. Date: Jul. 2, 2026

(54) PORTABLE HYDROGEN WATER PREPARATION CONTAINER

(71) Applicant: Echo Technologies LLC, Pleasant Grove, UT (US)

(72) Inventors: Josh Carr, Pleasant Grove, UT (US); Kurt Magellan, Spanish Ford, UT (US); Deven Stephens, Holladay, UT (US)

(21) Appl. No.: 19/002,469

(22) Filed: Dec. 26, 2024

(51) Int. Cl. C02F 1/461; A47G 19/22; B65D 41/06; B65D 51/16

(52) U.S. Cl. CPC C02F 1/46104; A47G 19/2205; B65D 41/06; B65D 51/1683; C02F 2201/004; C02F 2201/005; C02F 2201/4612

(57) ABSTRACT

A portable apparatus for generating and storing hydrogen water includes a reservoir for water that includes a neck and mouth at a top end, an opening on the bottom end, and one or more lateral sides. The apparatus further includes a hydrogen generating unit, having a top, a bottom, and lateral sides. The top end of the hydrogen generating unit is attached to the bottom end of the reservoir. A shell surrounds the bottom end of the hydrogen generating unit, the lateral sides of reservoir, and the top end of the reservoir surrounding the neck of the reservoir.

### TECHNICAL FIELD

The present invention relates to hydrogen water container and, more specifically, to portable hydrogen water preparation apparatus, which includes a reservoir to store water, a hydrogen generating unit located at the bottom of the reservoir. The produced hydrogen is dissolved in the water within the reservoir, wherein the water is converted into hydrogen water.

### BACKGROUND

Normally, hydrogen water refers to water that has been enhanced with molecular hydrogen gas (H2), and is also known as hydrogen-rich water and hydrogenated water. Hydrogen water has been the subject of many studies. Hydrogen water is said to increase energy, reduce inflammation, and reduce recovery times after workouts. Hydrogen water is believed to contain antioxidants, which help prevent oxidative stress. This type of stress comes from both normal body functions and external forces, including sun exposure and industrial chemicals. Oxidative stress has been linked to cancer and other diseases.

Some studies also suggest hydrogen water may be anti-inflammatory, a quality that may reduce the risk of heart disease and other life-threatening diseases. Another study found that hydrogen water could help manage high cholesterol, a major factor in heart disease. Other research has shown that hydrogen water can reduce the symptoms of angina, a type of chest pain linked to heart disease, and may help arteries work better.

Hydrogen water preparation apparatuses and containers are known in the art. These include US Patent Application 2019/0118124 A1, entitled “Hydrogen water and magnetic water generating water bottle”, Korean Patent KR101320463B1, entitled “Apparatus for manufacturing hydrogen water”, and Chinese Patent CN104775131B, entitled “Portable hydrogen water preparation apparatus.” However, these and other hydrogen water containers and generating devices, while being portable, are large in size and inconvenient to carry. Additionally, these prior art devices contain multiple seams that are prone to high pressure failure and are composed of two or more parts that have limited ability to handle high pressure. The prior art devices also are configured with electronics and battery components that are prone to failure in the event of water leakage from the water continuing bottle to the hydrogen generating portion of the device.

### SUMMARY OF THE INVENTION

An embodiment of the invention id drawn to a portable apparatus for generating and storing hydrogen water. The apparatus includes a reservoir for water that includes a neck and mouth at a top end, an opening on the bottom end, and one or more lateral sides. The apparatus further includes a hydrogen generating unit, having a top, a bottom, and lateral sides. The top end of the hydrogen generating unit is attached to the bottom end of the reservoir. A shell surrounds the bottom end of the hydrogen generating unit, the lateral sides of reservoir, and the top end of the reservoir surrounding the neck of the reservoir. One or more panels containing a circuit board and at least one battery are located between the one or more lateral sides of the reservoir and the lateral sides of the shell.

In another embodiment, a portable apparatus for generating and storing hydrogen water includes a reservoir for water, wherein the reservoir includes a neck and mouth at a top end, an opening on the bottom end, and two lateral sides. A hydrogen generating unit, having a top, a bottom, and lateral sides. The top end of the hydrogen generating unit is attached to the bottom end of the reservoir. The apparatus also includes a shell surrounding the bottom end of the hydrogen generating unit, the lateral sides of reservoir, and the top end of the reservoir surrounding the neck of the reservoir. The reservoir, hydrogen generating unit, and shell have a rectangular shape. One or more panels contain a circuit board and at least one battery, and are located between the one or more lateral sides of the reservoir and the lateral sides of the shell.

In particular embodiments of the invention, the apparatus may include a removable lid to seal the mouth of the reservoir. The lid may include a bayonet-style mechanism and a pressure valve to regulate the pressure inside of the reservoir. The lid may further include manual release valve on the removable lid to reduce pressure inside of the reservoir. The lid may also include a cap covering the pressure valve and the manual release valve, wherein the cap is adapted to activate the manual release valve.

### BRIEF DESCRIPTION OF THE DRAWINGS

FIG. 1 is a front view of the container according to an embodiment of the invention;

FIG. is a side view of the container according to an embodiment of the invention; and

FIG. 3 is a top view of the container according to an embodiment of the invention;

FIG. 3A is a cross-sectional view of the container take along lines A-A of FIG. 3 according to an embodiment of the invention;

FIG. 4 is a perspective view of the lid of the container according to an embodiment of the invention;

FIG. 5 is an exploded view of the interaction between the lid and the bayonet-style mechanism to secure the lid onto the mouth of the reservoir according to an embodiment of the invention;

FIG. 6 is a cross-sectional view of the lid and mouth of the reservoir showing the pressure release mechanisms according to an embodiment of the invention;

FIG. 7 is a cross-sectional view of the hydrogen generating unit attached to the bottom end of the reservoir;

FIG. 8 is a perspective view of a clamp for attaching the reservoir unit and the hydrogen generating unit;

FIG. 9 is a perspective view of a rib structure overlapping the hydrogen generating unit;

FIG. 10 is a perspective view of a silicone layer attached to the lateral sides of the generating unit; and

FIG. 11 is a perspective view of the hydrogen generating unit.

### DETAILED DESCRIPTION OF THE INVENTION

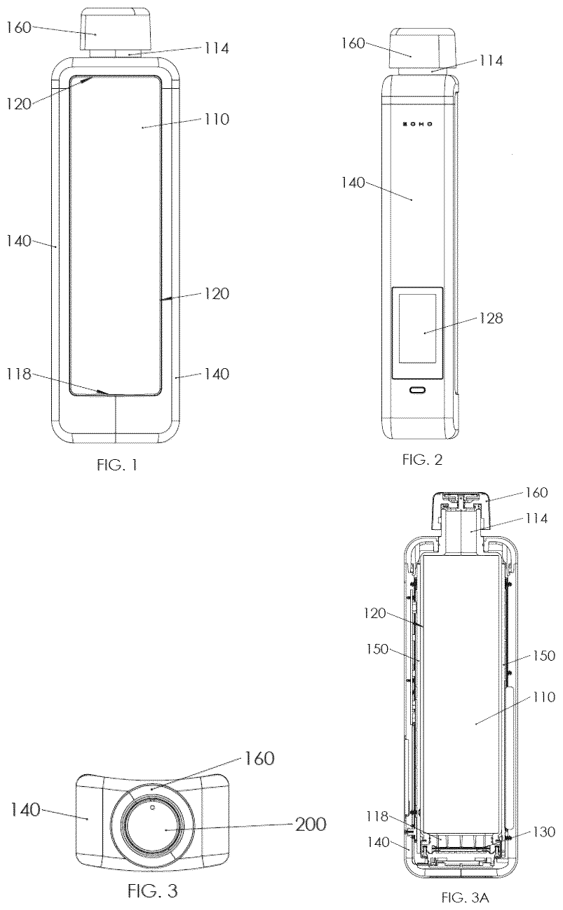

The present disclosure provides a hydrogen water preparation apparatus and container having a robust structure and excellent portability. As shown in FIGS. 1-3A, exemplary embodiments of the present invention provide a portable apparatus 100 for generating and storing hydrogen water, including a reservoir 110 for water, wherein the reservoir includes a neck and mouth 114 at a top end, an opening on the bottom end 118, one or more lateral sides 120, as shown in FIGS. 1 and 3A. The reservoir can be formed by any suitable lightweight plastic material, such as polycyclohexylene dimethylene terephthalate (PCGT). In a particular embodiment, the reservoir 110 consists of a high pressure plastic bottle capable of holding 90 pounds of pressure and creating 10 ppm of hydrogen in water. A hydrogen generating unit 130, includes a top end 132 that is attached to the bottom end 118 of the reservoir, as shown in FIG. 7. Hydrogen water is made using a process called electrolysis, wherein water enters the hydrogen water generating unit and is broken down into its components, hydrogen and oxygen. The oxygen is expelled, while the antioxidant-packed hydrogen bubbles are dissolved back into the water.

A shell 140 surrounds the bottom end of the hydrogen generating unit 130, the lateral sides of reservoir 120, and the top end 122 of the reservoir surrounding the neck 114 of the reservoir. The shell 140 provides additional support to the reservoir 110 and the hydrogen generating unit 130, as well as providing protection to the battery and circuitry therein. The placement of the battery between a side wall 120 of the reservoir 110 and the shell 140 provides additional space for use of a larger battery without compromising the size of the container base and allowing the container to be designed with a thinner base. The shell 140 may be made from any suitable rigid (e.g., plastic) or suitable flexible material (e.g., rubber). One or more panels 150 are included to contain a circuit board and at least one battery. The one or more electronic panels 150 are located between the one or more lateral sides 120 of the reservoir 110 and the lateral sides of the shell 150. The one of more panels 150 may be located on an uppermost portion of the shell 140 to place all circuitry and battery from the bottom portion of the shell 140 and reservoir 120 while the apparatus is placed in an upright position. In a particular embodiment, the one or more panels 150 can include a moisture barrier for water proofing the electronic components and the at least one battery from any liquids that may breach the shell 140 or reservoir 110.

As is known in the art, the battery includes two poles connected with a couple of electrodes. A power input, a display unit, and an external power source for charging a rechargeable battery is provided. A power switch activates the power to the battery and can include an automatic shutoff feature to stop power input when the battery is fully charged. The battery is in electrical contact with the circuitry and hydrogen generating unit 130.

As shown in FIG. 2, a display unit 128 can be formed on the one of the side walls of the shell 140 and can be lit using general mini bulb or light emitting diode (LED) light. The display unit 128 may also include a control panel for selecting various features and operational controls of the container 100.

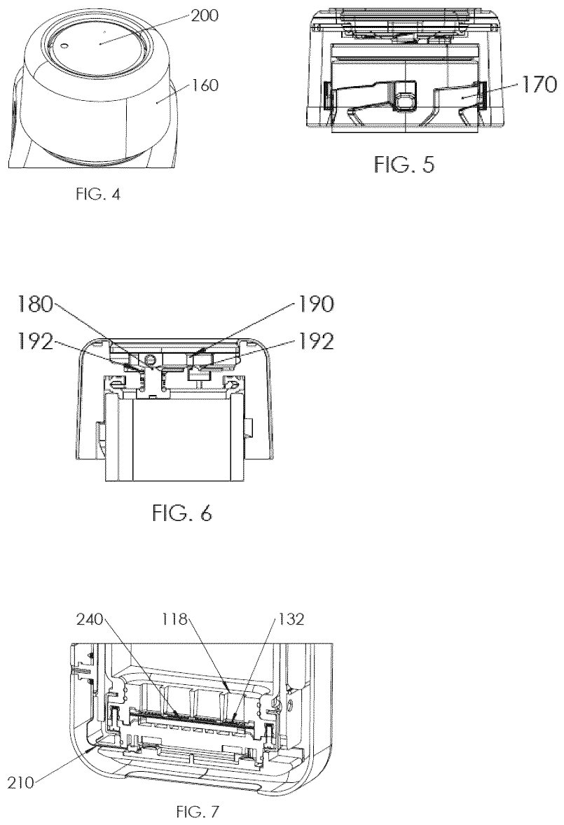

In another embodiment, the portable apparatus 100 may include a removable lid 160 to seal the mouth of the reservoir, wherein the lid 160 may include a bayonet-style mechanism 170 and a pressure valve 180 to regulate the pressure inside of the reservoir to a predetermined pressure level, as shown in FIGS. 1-7. The bayonet-style mechanism includes any fastening mechanism consisting of a cylindrical male side with one or more radial pins, and a female receptor with matching generally L-shaped slot(s).

In an alternative embodiment, the portable apparatus 100 can also include a manual release valve 190 on the removable lid 160 to manually reduce or eliminate pressure inside of the reservoir. A cap 200 covering the pressure valve 180 and the manual release valve 190, wherein the cap 200 is adapted to activate the manual release valve 190. In a particular embodiment, the pressure valve 180 and the manual release valve 190 include valve springs 192. Unlike threaded caps used in the prior art, the lid 160 of the present embodiment allows sealing of the reservoir mouth with a quarter turn of the lid 160. Significantly, the lid 160 creates a tighter seal as the pressure increases with active hydrogenation of the water in the reservoir 110, up to a predetermined pressure point. To unseal the lid, the operator depresses the cap 200 in order to activate the manual release valve 190, thus releasing the built-up pressure within the reservoir 110, which facilitates the detachment of the lid 160.

In yet another embodiment of the portable apparatus 100, the reservoir unit 110 and hydrogen generating unit 130 each comprise a generally rectangular shape on their respective top, bottom, and/or lateral sides, as shown in FIGS. 1-4, 9, and 10. The rectangular shape of the hydrogen generating unit 130 maximizes the surface area in contact with the water in the reservoir 110, thus providing faster hydrogenation. It has been found that the rectangular shape of the reservoir unit allows higher pressure tolerance within the reservoir. The rectangular shape of the hydrogen generating unit 130 has been found to advantageously provide greater surface area to produce faster and higher levels of hydrogenation when compared to the standard circular hydrogen generating units found in prior art devices. Additionally, the rectangular shape of the container provides a desirable ergonomic design that allows a comfortable and stable grip.

In specific embodiments, the portable apparatus 100, the reservoir unit and hydrogen generating unit can be attached via a clamp 210. In some embodiments, the clamp 210 may be a snap-fit joint, as show in FIGS. 7 and 8. The clamp 210 provides an attachment means that can withstand high pressure yet provide flexibility between the reservoir 110 and the attached hydrogen generating unit 130, which is critical given the pressure changes experienced during hydrogen water formation. The clamping mechanism also facilitates changing or replacing the hydrogen generating unit 130.

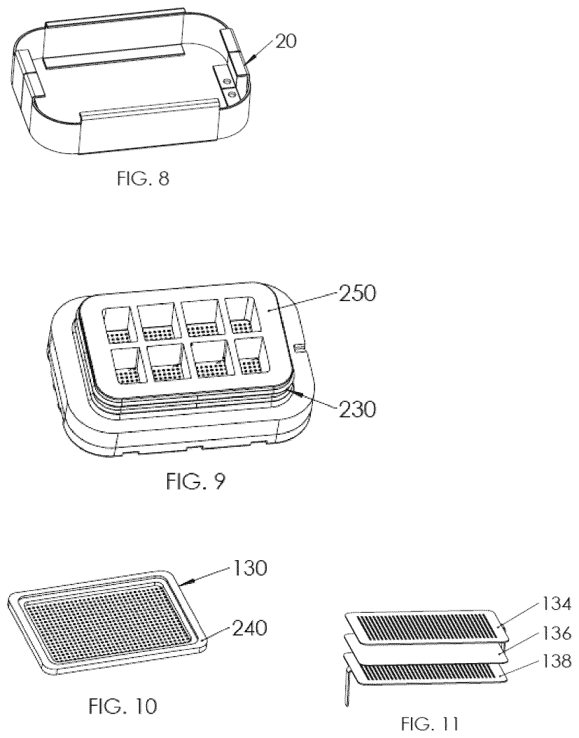

In alternative embodiments, the hydrogen generating unit 130 includes an upper electrode 134, a bottom electrode 138, and a barrier film 136 located between the upper electrode 134 and the bottom electrode 138, as shown in FIG. 11. The barrier film, such as a polymeric membrane, allows hydrogen molecules to dissolve into the water in the reservoir while preventing the oxygen produced through hydrogen generation process from contacting the water, with the oxygen being release outside of the container. The generating unit 130 can include o-rings 230 (FIG. 9) or, alternatively, an elastomeric material layer 240 (e.g., silicone) attached to the lateral sides of the hydrogen generating unit 130. The elastomeric material layer 240 may be premolded onto the hydrogen generating unit 130 prior to assembly. In another embodiment, the hydrogen generating unit 130 can include a rib structure 250 overlapping the same, which protects the surface of the hydrogen generating unit 130 from the contents of the reservoir 110, such as when ice is included in the reservoir.

In particular embodiments, the top, bottom, and sides of the reservoir 110 may have a thickness of at least 1 mm. in order to provide more pressure tolerance within the reservoir 110 when the water therein is pressurized to increase the hydrogen content of the water, particularly when compared to standard reservoirs that are made with thinner wall thicknesses. In particular embodiments, the top, bottom, and sides of the reservoir 110 have a thickness of 1.3 mm to 1.5 mm. in alternative embodiments, the reservoir may be manufactured to have double walls.

1. A portable apparatus for generating and storing hydrogen water, comprising:
a reservoir for water, wherein the reservoir includes a neck and mouth at a top end, an opening on the bottom end, one or more lateral sides;
a hydrogen generating unit, having a top, a bottom, and lateral sides, wherein the top end of the hydrogen generating unit is attached to the bottom end of the reservoir;
a shell surrounding the bottom end of the hydrogen generating unit, the lateral sides of reservoir, and the top end of the reservoir surrounding the neck of the reservoir; and
one or more panels containing a circuit board and at least one battery, wherein the one or more electronic panels are located between the one or more lateral sides of the reservoir and the lateral sides of the shell.

2. The portable apparatus of claim 1, further comprising a removable lid to seal the mouth of the reservoir, wherein the lid comprises a bayonet-style mechanism and a pressure valve to regulate the pressure inside of the reservoir.

3. The portable apparatus of claim 2, further comprising manual release valve on the removable lid to reduce pressure inside of the reservoir.

4. The portable apparatus of claim 3, further comprising a cap covering the pressure valve and the manual release valve, wherein the cap is adapted to activate the manual release valve.

5. The portable apparatus of claim 3, wherein the pressure valve and the manual release valve comprise spring valve springs.

6. The portable apparatus of claim 1, wherein the reservoir unit and hydrogen generating unit each comprise a rectangular shape on its top, bottom, and lateral sides.

7. The portable apparatus of claim 1, wherein the reservoir unit and hydrogen generating unit are attached via a clamp.

8. The portable apparatus of claim 7, wherein the clamp is a snap-fit joint.

9. The portable apparatus of claim 7, further comprising o-rings or a silicone layer attached to the lateral sides of the generating unit.

10. The portable apparatus of claim 1, wherein the top, bottom, and sides of the reservoir have a thickness of at least 1 mm.

11. The portable apparatus of claim 1, wherein the one or more panels comprise a moisture barrier for water proofing the electronic components and the at least one battery.

12. The portable apparatus of claim 1, further comprising a rib structure overlapping the hydrogen generating unit.

13. The portable apparatus of claim 1, wherein the hydrogen generating unit comprises an upper electrode, a bottom electrode, and a barrier film located between the upper electrode and the bottom electrode.

14. The portable apparatus of claim 1, wherein the shell comprises an elastomeric material.

15. A portable apparatus for generating and storing hydrogen water, comprising:
a reservoir for water, wherein the reservoir includes a neck and mouth at a top end, an opening on the bottom end, one or more lateral sides;
a hydrogen generating unit, having a top, a bottom, and lateral sides, wherein the top end of the hydrogen generating unit is attached to the bottom end of the reservoir;
a shell surrounding the bottom end of the hydrogen generating unit, the lateral sides of reservoir, and the top end of the reservoir surrounding the neck of the reservoir;
one or more panels containing a circuit board and at least one battery, wherein the one or more electronic panels are located between the one or more lateral sides of the reservoir and the lateral sides of the shell; and
a removable lid to seal the mouth of the reservoir, wherein the lid comprises a bayonet-style mechanism and a pressure valve to regulate the pressure inside of the reservoir and a manual release valve on the removable lid to remove pressure inside of the reservoir.

16. The portable apparatus of claim 15, further comprising a cap covering the pressure valve and the manual release valve, wherein the cap is adapted to activate the manual release valve.

17. A portable apparatus for generating and storing hydrogen water, comprising:
a reservoir for water, wherein the reservoir includes a neck and mouth at a top end, an opening on the bottom end, and two lateral sides;
a hydrogen generating unit, having a top, a bottom, and lateral sides, wherein the top end of the hydrogen generating unit is attached to the bottom end of the reservoir;
a shell surrounding the bottom end of the hydrogen generating unit, the lateral sides of reservoir, and the top end of the reservoir surrounding the neck of the reservoir;
wherein the reservoir, hydrogen generating unit, and shell have a rectangular shape; and
one or more panels containing a circuit board and at least one battery, wherein the one or more electronic panels are located between the one or more lateral sides of the reservoir and the lateral sides of the shell.

18. The portable apparatus of claim 17, further comprising a removable lid to seal the mouth of the reservoir, wherein the lid comprises a bayonet-style mechanism and a pressure valve to regulate the pressure inside of the reservoir.

19. The portable apparatus of claim 18, further comprising manual release valve on the removable lid to reduce pressure inside of the reservoir.

20. The portable apparatus of claim 19, further comprising a cap covering the pressure valve and the manual release valve, wherein the cap is adapted to activate the manual release valve.
